(19) United States
(12) Patent Application Publication
(10) Pub. No.: US 2003/0084081 A1
(43) Pub. Date: May 1, 2003

(54) Method and apparatus for transposing a two dimensional array

(76) Inventor: Bedros Hanounik, Cupertino, CA (US)

Correspondence Address: Bedros Hanounik, Apt. 5308, 19608 Pruneridge Ave, Cupertino, CA, 95014, US

(21) Appl. No.: 10/004,617

(22) Filed: Oct. 27, 2001

(51) Int. Cl. G06F 17/14

(52) U.S. Cl. 708/400

(57) ABSTRACT

A method of transposing an array using diagonal access. An array of m rows, m diagonals up, and m diagonals down. Rows and diagonals access the same array using different mapping functions. Each row comprising n data element. Each diagonal comprising of n data element. First, every row of the array is loaded into the diagonals up with same index number in a new storage array. Second, every row of the new array is rotated by its index number. Third, the new array is stored back in the original array using the diagonals down. The result, a transposed array of the original array is completed.

### FIELD OF THE INVENTION

The present invention relates to the field of computer systems and more particularly to transposing a two-dimensional array using a single instruction multiple data (SIMD) computer and diagonal access of a memory array, or multi-processors computer, which allows diagonal access to the processors, and distributed memory system.

### BACKGROUND OF THE INVENTION

A two-dimensional array of data is a matrix of rows and columns. Every data element in the array can be uniquely identified by its row and column indices. One example of a two-dimensional array (will be referred to by matrix in the rest of the text) is an image stored in rows and columns; every data element represents the color depth of one dot (referred to as pixel) in the image. To manipulate the image, one may require to access both the rows and the columns of the matrix. The operation that transforms rows into columns and columns into rows in a matrix is known as matrix transpose, or just transpose.

Matrix transpose is very useful to allow easy access to both rows and columns of a two-dimensional array. For example to compress an image , at one stage, a one dimension discrete cosine transform (DCT) is operated on the rows and then operated on the columns of the image. Easy access to the columns in this case is critical to achieve fast two-dimensional DCT, and as a result fast compression.

Single Instruction Multiple Data (SIMD) computers allow execution of same operation on the entire row of data. This is useful when a single operation is repeatedly executed on data that is aligned in one row. SIMD computers require transpose operation to be able to manipulate data that resides on the column of the matrix.

Diagonal access is a two-dimensional memory array that allows the access to the diagonals of its contents in addition to the conventional row access of its contents. The diagonal could be a diagonal down, where the next data element of the array is on a lower step; or the diagonal could be a diagonal up, where the next data element is on an upper step.

Many other applications for matrix transpose exist in database systems. Database system consists of records stored in rows; Same field of every record are stored in one column. For example a database that holds employees records could be organized as follows: Fields of name, address, salary, and position of every employee are stored in one row. If the computer system updates the salaries of all employees, it will be time consuming to access every row and update the salary field of every row. An alternative way is to transpose the matrix. In the latter case, the salary fields of all employees are in one row and the computer system can operate on all salary fields concurrently.

In many cases the transpose operation is very expensive and many applications try to avoid this operation by operating on the data stored in columns one element at a time, which makes SIMD computers less efficient ones.

### BRIEF SUMMARY OF THE INVENTION

A method and apparatus of transposing an array using diagonal access is described. An array of m rows each row comprising n data element, and therefore the whole array comprising of n columns. each diagonal comprising of n data element. First, every row of the array is loaded into the diagonals up with same index number in a new storage array. Second, every row of the new array is rotated by its index number. Third, the new array is stored back in the original array using the diagonals down. The result, a transposed array of the original array is completed.

Other features and detailed embodiments, as well as advantages of the present invention, will be clarified from the detailed description and drawings that follow.

### BRIEF DESCRIPTION OF THE DRAWINGS

The accompanying drawings, which are part of this specification, illustrate prior art and also embodiments of the present invention. This drawings along with the description, serve to explain the principle and usage of the present invention.

FIG. 1 illustrates an example of matrix transpose operation on 4×4 matrix size.

Prior Art FIG. 2 illustrates a method to transpose a matrix by using data interleaving techniques.

Prior Art FIG. 3 illustrates another method to transpose a matrix by using data interleaving techniques.

Prior Art FIG. 4 shows a basic SIMD computer that consists of data storage array, execution units, exchange unit, and their interconnections.

FIG. 5 shows how a two-dimensional memory array is accessed using a diagonal up or a diagonal down.

FIG. 6A illustrates a method for transposing an array in accordance with one embodiment of the present invention.

FIG. 6B illustrates a method for transposing an array in accordance with another embodiment of the present invention.

FIG. 7 illustrates a method for transposing an array in accordance with another embodiment of the present invention.

### DETAILS DESCRIPTION OF THE INVENTION

A method of transposing a two-dimensional array is described using series of diagonal access techniques and rotate operations to the array. For one embodiment of the present invention, the two-dimensional array consists of memory cells stored in vector register file. For another embodiment of the present invention, the two-dimensional array consists of blocks of memory in a parallel memory system (or refered to as interleaved memory). For another embodiment of the present invention, the two-dimensional array consists of multi-processors system with distributed memory.

A method for transposing a two dimensional array is described in more detail below.

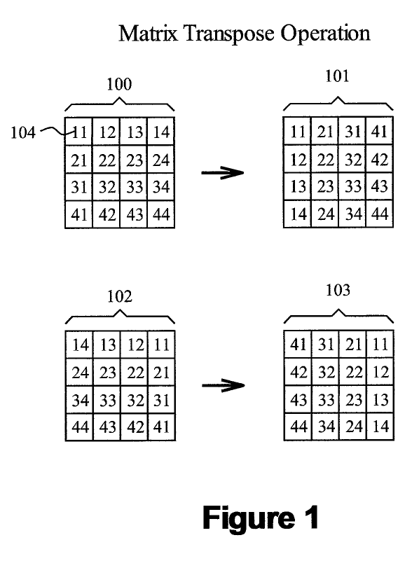

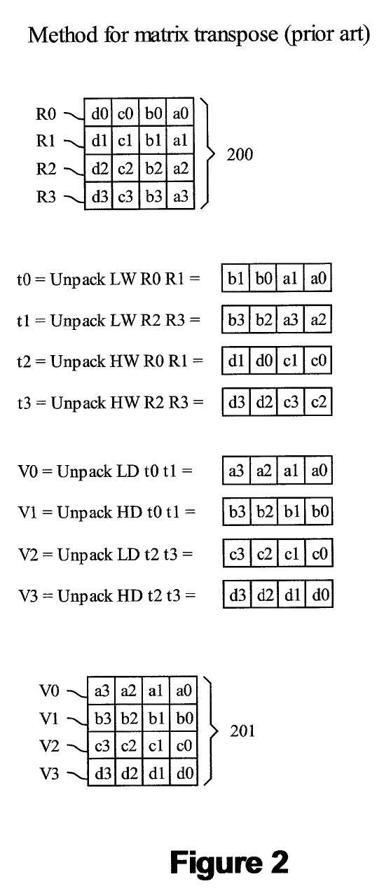

FIG. 1 shows two examples to execute matrix transpose. a 4×4 matrix 100 before transpose operation and the matrix 101 after being transposed. The numbers 104 inside the matrix represent the indices of the data elements stored in this matrix. This matrix 100 has the left upper corner as a starting point to index the rows and the columns. and the transpose is done along the main diagonal down (from upper left to lower right).

Also in FIG. 1 matrix 102 of size 4×4 is indexed starting from the upper right corner. The transposition is done along the main diagonal up (from upper right to lower left). The transposed matrix of 102 is shown in 103.

FIG. 2 and FIG. 3 illustrate a method for transposing a matrix using data interleaving. Block 200 is the matrix before transposition, and block 201 is the matrix after transposition. Block 300 is the matrix before transposition, and block 301 is the matrix after transposition. This method is illustrated in U.S. Pat. No. 5,815,421 titled Method For Transposing a Two Dimensional Array. R0-R3 represent row registers that hold the original data. t0-t3 represent temporary registers to hold temporary data. V0-V3 row registers that hold the resulted transposed matrix.

FIG. 4 shows a basic diagram of a SIMD computer. In accordance with one embodiment of the present invention, the block 400 represents a two-dimensional array of memory cells 405. This array has m rows numbered R0 to Rm−1 401. The rows extend along the SIMD computer as in 402; every row in the array 400 has a different coloring pattern 402 to illustrate this feature. The same array 400 comprises 404 of n columns 410. Every column 410 comprises of a plurality of memory cells; the number of memory cells in every column, that reside in a single row, can be either 8, 16, 32, 64, 128, or larger; corresponding to 8, 16, 32, 64, 128 bit, or larger, the size of an execution unit 408. The plurality of memory cells that reside in one column and one row are called words; therefore a row consists of n words, each word corresponds to a different column. The two-dimensional array 400 comprises of n×m words. Every word can be uniquely identified by two indices, row index identifies the row being selected and column index identifies the column being selected. The word that resides on the crossing of the column and row being selected, get selected. The words that reside in the same row share the same row index. The words that reside in the same column share the same column index. All the words of a single column have common data lines 406 that allow accessing and modifying the data stored in the storage memory cells 405. The memory cells of every word are selected through the select lines 403. Every column is attached to an execution unit or a plurality of execution units 408. Also the columns in the SIMD computer illustrated in FIG. 4 are attached to an exchange unit that allows data shuffle among the data elements that appear on the buses 407 that connect the array 400 and both of execution units 408 and exchange unit 409.

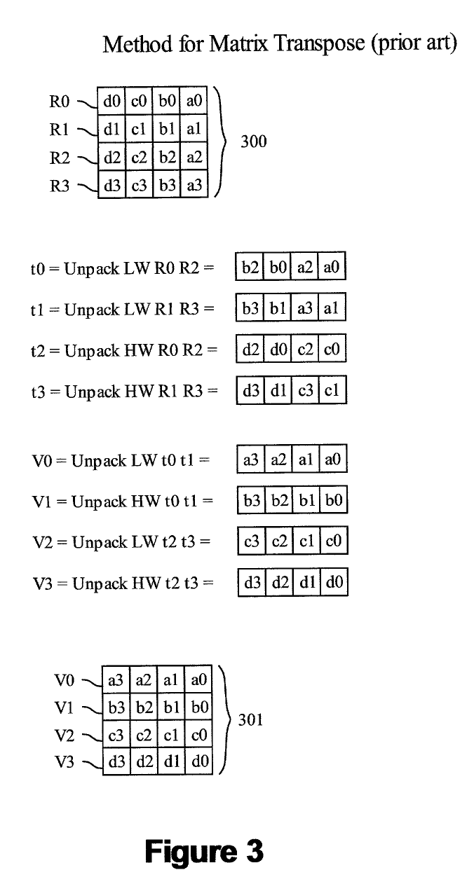

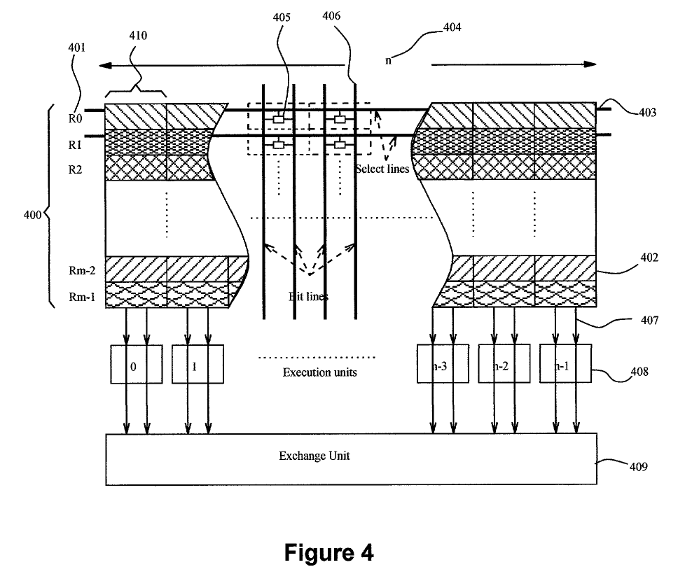

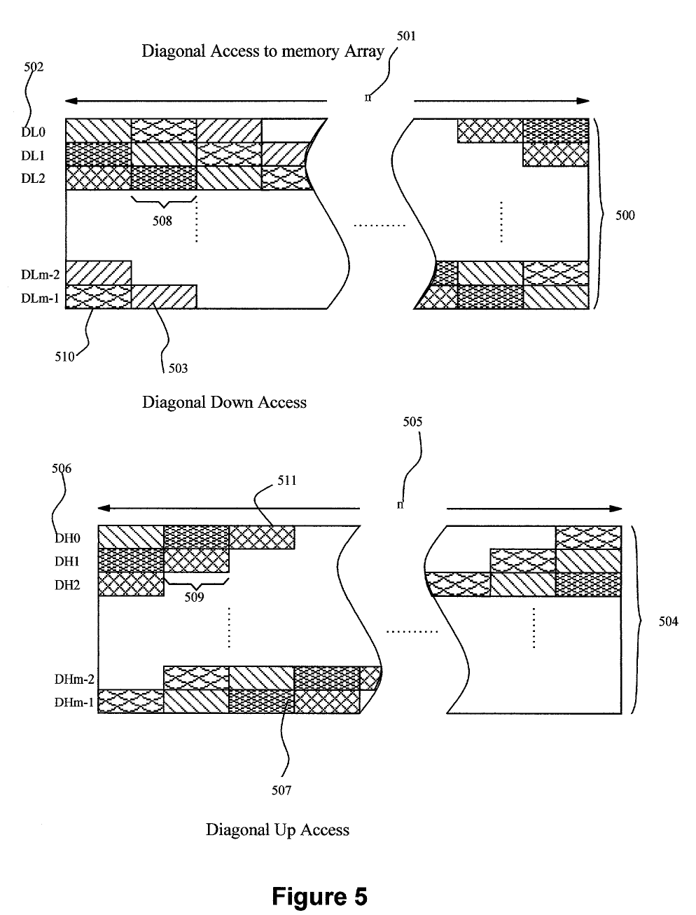

FIG. 5 shows how diagonal up and diagonal down access techniques are mapped into a two-dimensional array in accordance with one embodiment of the present invention. There is m diagonal down DL0 to DLm−1 502, each comprises of n 501 of words 508. There is m diagonal up DH0 to DHm−1 506, each comprises of n 505 of words 509. The diagonal down array 500 and the diagonal up array 504 shares the same array 400 of SIMD computer illustrated in FIG. 4 with different access patterns. The new access patterns, in accordance with one embodiment of the present invention, is shown in 503 and 507. Different coloring patterns of the array 500 represent different diagonals of the same array. Different coloring patterns of the array 504 represent different diagonals of the same array. For clarity purposes, not all the diagonals are shown with patterns in array 500 and array 504 The mapping functions of the words of a row in the array to the words of a diagonal up and a diagonal down are as follows:

DL(i,j)=R((i+j)MODm, j)

DH(i,j)=R((m+i−j)MODm, j)

DL: data element of diagonal down

DH: data element of diagonal up

R: data element of row

m: number of rows

i: row index 0 to m−1

j: column index 0 to n−1

In accordance with one embodiment of the present invention, the diagonals down wrap around the array 500 when they reach the lower edge 510 of the array. In accordance with one embodiment of the present invention, the diagonals up wrap around the array 504 when they reach the upper edge 511 of the array.

The two-dimensional array, in accordance with one embodiment of the present invention, can also be comprised of mesh connected multi-processors. The word 508 or 509 can be a memory block that resides in a processor. The rows 401 and diagonals 502 and 506 are, in the multi-processors case, rows and diagonals in a mesh of connected multi-processors.

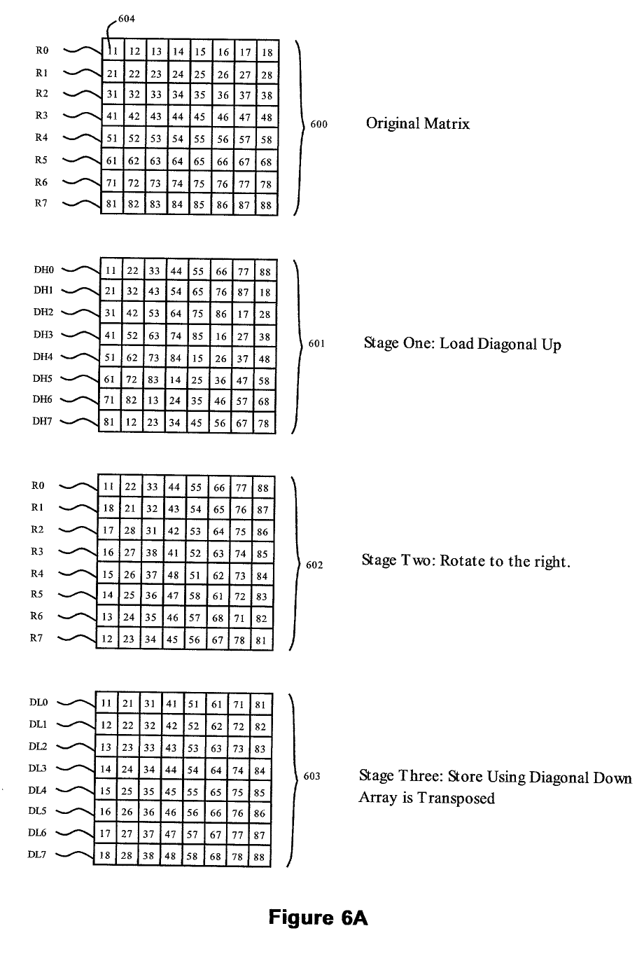

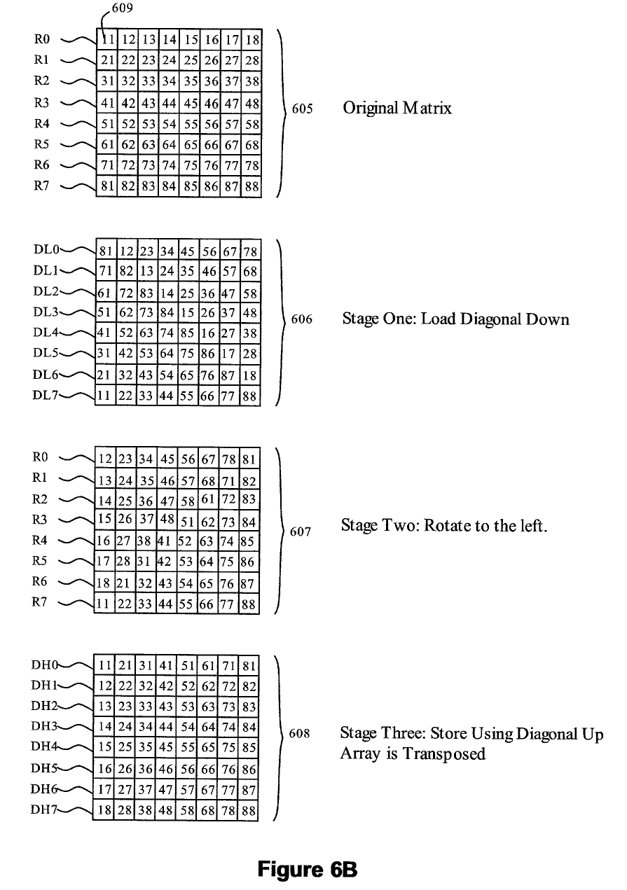

FIG. 6A shows an example that illustrates one method for transposing a two-dimensional array in accordance with one embodiment of the present invention. The example is done using array size of 8×8, but the method can be used on any array of size m×n, where m is the number of rows and n is the number of columns. The transpose is done along the main diagonal down of the array.

The numbers 604 represent the indices of the data elements of the original array. The array 600 represents the original matrix before transposition. The array 601 represents the matrix after loading the diagonals DH from with the original matrix. DH(i) gets the data stored in row R(i) of the original matrix. The array 602 represents the matrix after performing the following rotations on the rows of the matrix 601: The row R(i) of the array is rotated to the right by the value of its index i. For example, row R(1) rotates its contents by 1 to the right, row R(2) rotates its contents by 2 to the right.

The array 603 represents the final stage; every diagonal down DL is read and stored to its corresponding row as follows:

DL(0) is stored in row R(0) of the final transposed matrix.

DL(m−1) is stored in row R(1) of the final transposed matrix.

DL(m−2) is stored in row R(2) of the final transposed matrix.

repeat for all diagonals down

A method to transpose a matrix, in accordance with the present invention is illustrated as follows:

1. Load the contents of row R(i) of the original matrix into the diagonal up DH(i) of a temporary matrix. Where i=0 to m−1, m is the number of rows in the original matrix. (600)

2. Rotate the contents of every row of the temporary matrix to the right by the value of its row index.

3. Store the contents of DL(i) of the temporary matrix into the row R(m−i MOD m) of the original matrix. Where i=0 to m−1

4. The original matrix is transposed.

FIG. 6B illustrates one method for transposing a two-dimensional array in accordance with one embodiment of the present invention. The example is done using array size of 8×8, but the method can be used on any array of size m×n, where m is the number of rows and n is the number of columns. The transpose is done along the main diagonal down of the array.

The numbers 609 represent the indices of the data elements of the original array. The array 605 represents the original matrix before transposition. The array 606 represents the matrix after loading the diagonals DL from the original matrix. DL(m−i−1) gets the data stored in row R(i) of the original matrix; where m is the size of matrix. The array 607 represents the matrix after performing the following rotations on the rows of the matrix:

The row R(i) of the array is rotated to the left by the value (i+1)MODn. For example, row R(0) rotates its contents by 1 to the left, row R(1) rotates its contents by 2 to the left. The array 608 represents the final stage; every diagonal up DH is read and stored to its corresponding row as follows:

DH(m−1) is stored in row R(0) of the final transposed matrix.

DH(0) is stored in row R(1) of the final transposed matrix.

DH(1) is stored in row R(2) of the final transposed matrix.

repeat for all diagonals up

A method to transpose a matrix, in accordance with the present invention is illustrated as follows:

1. Load the contents of row R(i) of the original matrix into the diagonal down DL(m−i−1) of a temporary matrix. Where i=0 to m, m is the number of rows in the original matrix. (605)

2. Rotate the contents of every row of the temporary matrix to the left by the value of (i+1)MODn.

3. Store the contents of DH(i) of the temporary matrix into the row R((i+1) MOD m) of the original matrix. Where i=0 to m−1

4. The original matrix is transposed.

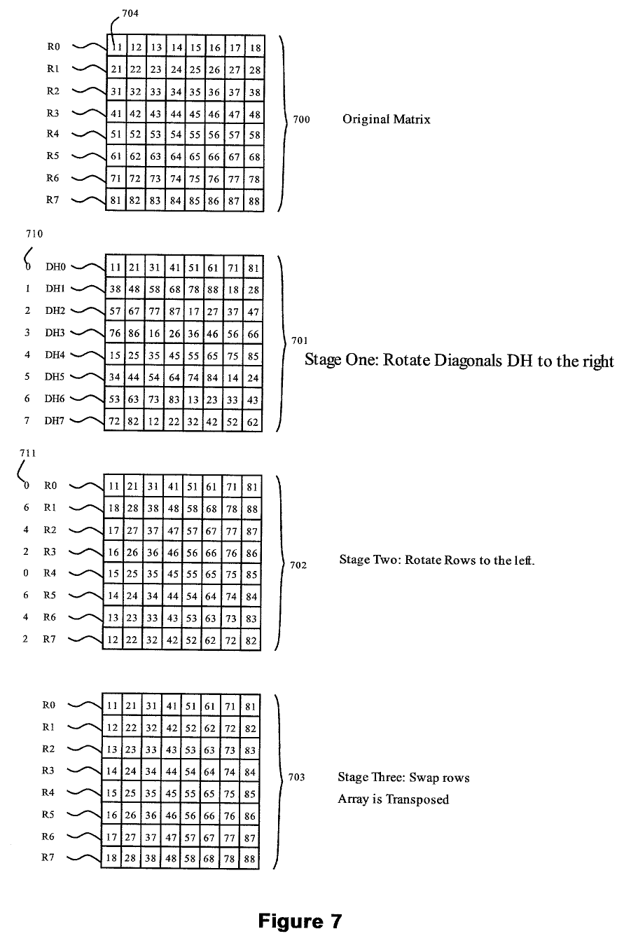

FIG. 7 illustrates one method for transposing a two-dimensional array in accordance with one embodiment of the present invention. The example is done using array size of 8×8, but the method can be used on any array of size m×n, where m is the number of rows and n is the number of columns. The transpose is done along the main diagonal down of the array. The numbers 704 represent the indices of the data elements of the original array. The array 700 represents the original matrix before transposition. The array 701 represents the original matrix after rotating the diagonal up DH(i) to the right by the value of its index i. Where i=0 to m−1. The value of the rotation is indicated by 710. The array 702 represents the matrix 701 after rotating the row R(i) by the value (2m−2i) MOD m to the left. The value of the rotations indicated by 711. The array 703 represents the final stage; the row R(i) in matrix 702 are swapped with the row R(m−i−1). Where i=1 to └m−1/2┘

A method to transpose a matrix, in accordance with the present invention is illustrated as follows:

1. Rotate the contents of diagonal up DH(i) of the original matrix 700 to the right by the value of its index i 710. Where i=0 to m−1

2. Rotate the contents of every row R(i) of the matrix 701 to the left by the value (2m−2i) MOD m. Where i=0 to m−1.

3. From the matrix 702, swap the row R(i) with the row R(m−i−1). Where i=1 to └m−1/2┘

4. The matrix 700 is transposed into 703.

The present invention has been described in the foregoing specification. Reference to specific exemplary embodiments has been made. Thereof, It will, however, be evident that various changes and modifications could be made thereto without losing the broader spirit and scope of the invention. The drawings and specification are, accordingly, to be regarded in an illustrative rather than a restrictive sense.

What is claimed:

1. A method of manipulating data elements in transposing an array of m rows, each row comprising a plurality of n data elements; the transposition is done along the main diagonal down of the matrix. The method has the following steps:
Load the contents of row R(i) of the original matrix into the diagonal up DH(i) of a temporary matrix. Where i=0 to m−1, m is the number of rows in the original matrix.
Rotate the contents of every row of the temporary matrix to the right by the value of its row index.
Store the contents of DL(i) of the temporary matrix into the row R(m−i MOD m) of the original matrix. Where i=b 0 to m−1

2. The method in claim 1 is modified as follows to perform matrix transpose along the main diagonal down of the matrix. The method has the following steps:
Load the contents of row R(i) of the original matrix into the diagonal down DL(m−i−1) of a temporary matrix. Where i=0 to m, m is the number of rows in the original matrix.
Rotate the contents of every row of the temporary matrix to the left by the value of (i+1)MODn.
Store the contents of DH(i) of the temporary matrix into the row R((i+1) MOD m) of the original matrix. Where i=0 to m−1
The original matrix is transposed.

3. A method of manipulating data elements in transposing an array of m rows, each row comprising a plurality of n data elements; the transposition is done along the main diagonal down of the matrix. The method has the following steps:
Rotate the contents of diagonals up DH(i) of the original matrix to the right by the value of their index i. Where i=0 to m−1
Rotate the contents of every row R(i) of the matrix resulted from previous step to the left by the value (2m−2i) MOD m. Where i=0 to m−1.
In the matrix resulted from previous step, swap the row R(i) with the row R(m−i−1). Where i=1 to └m−1/2┘

4. In the method of claims 1,2, and 3, the data elements may be a word of size 8-bit, 16-bit, 32-bit, 64-bit, 128-bit, or larger in a SIMD computer.

5. In the method of claims 1,2, and 3, the data elements may be blocks of memory in mesh-connected multi-processors, or any multi-processors that have two-dimensional array configuration.

6. In the method of claims 1,2, and 3, the data elements may be blocks of memory cells in a memory array.

7. Methods described in claims 1 and 2 can be used together back to back in a pipelined fashion to overlap steps and save execution cycles, when transposing a set of matrices, as follows:
Method of claim 1 starts a transpose by loading DH diagonals up, Rotate, and then Store DL diagonals down.
Method of claim 2 is used while method of claim 1 is still storing data. Since both methods of claims 1 and 2 use same DL diagonals in store and load state respectively, stages of load and store of different methods can process data concurrently.
Method of claim 2 starts loading data into the DL diagonal immediately after method of claim 1 stores data from the same DL diagonal.
Method of claim 2, then processes the rotation stage.
While Method of claim 2 is storing data using DH diagonals, method of claim 1 starts loading data into DH diagonals in the same manner described in the pervious item.
Repeat.

8. Method of claim 7 is modified to use method of claim 2 for first transpose, then use method of claim 1 to overlap and repeat as described in claim 7.

9. A set of registers that are mapped to the same two-dimensional memory array in a SIMD computer that the row registers have access to. This mapping is done according to the following mapping functions:
DL(i,j)=R((i+j)MODm, j)
DH(i,j)=R((m+i−j)MODm, j)
m: number of rows
i: row index 0 to m−1
j: column index 0 to n−1
R: two-dimensional array with row access

10. The claim 9 allows different sets of registers to share and access a two-dimensional memory array in a SIMD computer using row access pattern, diagonal up access pattern, or diagonal down access pattern.
